(19) United States
(12) Patent Application Publication
(10) Pub. No.: US 2016/0162162 A1
(43) Pub. Date: Jun. 9, 2016

(54) Text Processing Method and Touchscreen Device

(71) Applicant: Huawei Technologies Co., Ltd., Shenzhen (CN)

(72) Inventor: Tingji Liu, Shenzhen (CN)

(21) Appl. No.: 14/902,226

(22) PCT Filed: Aug. 31, 2013
(86) PCT No.: PCT/CN2013/082754

§ 371 Date: Dec. 30, 2015

(51) Int. Cl. G06F 3/0484; G06F 17/21; G06F 3/0488

(52) U.S. Cl. CPC G06F 3/04845; G06F 3/04883; G06F 3/04842; G06F 17/211

(57) ABSTRACT

A text processing method, where the method includes displaying text; acquiring an input of a user; and enlarging and displaying text in a first preset area according to the input, and at the same time, reducing and displaying text in a second preset area, to enable display of the text to stay in an initial state, which means to enable a character in the text to stay displayed at a location in a row and/or a column in which the character in the text is displayed before the enlarging and displaying text in a first preset area and at the same time reducing and displaying text in a second preset area is executed, to resolve a technical problem in the prior art that it is inconvenient for a user to view and select text due to a dense arrangement of the text.

### CROSS-REFERENCE TO RELATED APPLICATIONS

This application is a National Stage of International Application No. PCT/CN2013/082754, filed on Aug. 31, 2013, which is hereby incorporated by reference in its entirety.

### TECHNICAL FIELD

The present disclosure relates to the field of touchscreen devices, and in particular, to a text processing method and a touchscreen device.

### BACKGROUND

A touchscreen device (for example, a mobile phone, a tablet computer or an automatic teller machine having a touchscreen) works by using an X-Y electrode grid on the touchscreen device, and uses a voltage on the touchscreen device. When a finger approaches an electrode, a capacitance changes, and can be measured. By comparing measured values of all electrodes, a location point of the finger can be accurately positioned, that is, a touch location or the like is determined. At present, as functions of a portable terminal such as a mobile phone of a user are further enhanced, the user completes operations such as processing text, editing a short message service message, and searching for information by using the portable terminal such as a mobile phone in an increasing number of circumstances. However, due to a portability requirement, a size of a touchscreen of the portable terminal such as a mobile phone is strictly limited, and the touchscreen cannot be made large enough; therefore, text is densely arranged on the touchscreen device. As a consequence in this case, to edit or view the text, it is very difficult for the user to accurately move a cursor to a desired location by using a finger.

### SUMMARY

The present technical solutions provide a text processing method and a touchscreen device, to resolve a technical problem in the prior art that it is inconvenient for a user to view and select text due to a dense arrangement of the text, thereby bringing beneficial effects of facilitating user viewing and selection, improving operation efficiency of the user, and improving user experience.

According to a first aspect, an embodiment of the present disclosure provides a text processing method, where the method includes displaying text; acquiring an input of a user; and enlarging and displaying text in a first preset area according to the input, and at the same time, reducing and displaying text in a second preset area, to enable display of the text to stay in an initial state, where to enable display of the text to stay in an initial state means to enable a character in the text to stay displayed at a location in a row and/or a column in which the character in the text is displayed before the enlarging and displaying text in a first preset area and at the same time reducing and displaying text in a second preset area is executed; the enlarging and displaying text in a first preset area includes enlarging and displaying a character and/or character spacing in the text in the first preset area; and the reducing and displaying text in a second preset area includes reducing and displaying a character and/or character spacing in the text in the second preset area.

In a first possible implementation manner of the first aspect, when the acquiring an input of a user includes acquiring a touch location of the user, the first preset area is an area, of at least one character or at least one pixel, in proximity to the touch location; and the second preset area is an area, of at least one character or at least one pixel, in proximity to the first preset area and outside the first preset area.

With reference to the first possible implementation manner of the first aspect, in a second possible implementation manner of the first aspect, after the enlarging and displaying text in a first preset area according to the input, and at the same time, reducing and displaying text in a second preset area, the method further includes acquiring a movement of the touch location; determining a location of the first preset area according to the movement of the touch location, and enlarging and displaying text in the first preset area; and at the same time, determining a location of the second preset area according to the movement of the touch location, and reducing and displaying text in the second preset area, to enable the display of the text to stay in the initial state.

With reference to the first possible implementation manner of the first aspect, in a third possible implementation manner of the first aspect, after the enlarging and displaying text in a first preset area according to the input, and at the same time, reducing and displaying text in a second preset area, the method further includes displaying, in proximity to the touch location, a character or graphics; acquiring a movement of the touch location; determining a display location of the character or the graphics according to the movement of the touch location; and displaying the character or the graphics according to the display location.

With reference to the third possible implementation manner of the first aspect, in a fourth possible implementation manner of the first aspect, if the character or the graphics is in the first preset area, the character or the graphics is enlarged and displayed.

In a fifth possible implementation manner of the first aspect, when the acquiring an input of a user includes acquiring a particular character, the enlarging and displaying text in a first preset area includes enlarging and displaying the particular character; and the reducing and displaying text in a second preset area includes reducing and displaying text in an area, of at least one character or at least one pixel, in proximity to the particular character.

With reference to the fifth possible implementation manner of the first aspect, in a sixth possible implementation manner of the first aspect, the acquiring a particular character includes acquiring the particular character according to a character entered by the user; or acquiring the particular character according to an instruction entered by the user.

With reference to the first aspect or the first possible implementation manner of the first aspect or the second possible implementation manner of the first aspect or the third possible implementation manner of the first aspect or the fourth possible implementation manner of the first aspect or the fifth possible implementation manner of the first aspect or the sixth possible implementation manner of the first aspect, in a seventh possible implementation manner of the first aspect, during the enlarging and displaying text in a first preset area according to the input, and at the same time, reducing and displaying text in a second preset area, to enable display of the text to stay in an initial state, the method further includes displaying at least a part of the text according to an initial size.

According to a second aspect, a touchscreen apparatus is provided, where the apparatus includes a display unit configured to display text; and an acquiring unit configured to acquire an input of a user, where the display unit is further configured to enlarge and display text in a first preset area according to the input of the user acquired by the acquiring unit, and at the same time, reduce and display text in a second preset area, to enable display of the text to stay in an initial state, where to enable display of the text to stay in an initial state means to enable a character in the text to stay displayed at a location in a row and/or a column in which the character in the text is displayed before the enlarging and displaying text in a first preset area and at the same time reducing and displaying text in a second preset area is executed; the enlarging and displaying text in a first preset area includes enlarging and displaying a character and/or character spacing in the text in the first preset area; and the reducing and displaying text in a second preset area includes reducing and displaying a character and/or character spacing in the text in the second preset area.

In a first possible implementation manner of the second aspect, the acquiring unit is configured to acquire a touch location of the user; and the display unit is configured to, according to the touch location acquired by the acquiring unit, enlarge and display text in an area, of at least one character or at least one pixel, in proximity to the touch location, and at the same time, reduce and display text in an area, of at least one character or at least one pixel, in proximity to the first preset area and outside the first preset area.

With reference to the first possible implementation manner of the second aspect, in a second possible implementation manner of the second aspect, the acquiring unit is further configured to acquire a movement of the touch location, and acquire a location of the first preset area according to the movement of the touch location and/or acquire a location of the second preset area according to the movement of the touch location; and the display unit is further configured to enlarge and display text in the first preset area and at the same time, reduce and display text in the second preset area according to the location of the first preset area and the location of the second preset area that are acquired by the acquiring unit.

With reference to the first possible implementation manner of the second aspect or the second possible implementation manner of the second aspect, in a third possible implementation manner of the second aspect, the display unit is further configured to display, in proximity to the touch location, a character or graphics; the acquiring unit is further configured to acquire the movement of the touch location, and acquire a display location of the character or the graphics according to the movement of the touch location; and the display unit is further configured to display the character or the graphics according to the display location acquired by the acquiring unit.

With reference to the third possible implementation manner of the second aspect, in a fourth possible implementation manner of the second aspect, the display unit is further configured to, if the character or the graphics is in the first preset area, enlarge and display the character or the graphics.

In a fifth possible implementation manner of the second aspect, the acquiring unit is further configured to acquire a particular character; and the display unit is further configured to enlarge and display the particular character according to the particular character acquired by the acquiring unit, and at the same time, reduce and display text in an area, of at least one character or at least one pixel, in proximity to the particular character.

With reference to the fifth possible implementation manner of the second aspect, in a sixth possible implementation manner of the second aspect, the acquiring unit is configured to acquire the particular character according to a character entered by the user; or acquire the particular character according to an instruction entered by the user.

With reference to the second aspect or the first possible implementation manner of the second aspect or the second possible implementation manner of the second aspect or the third possible implementation manner of the second aspect or the fourth possible implementation manner of the second aspect or the fifth possible implementation manner of the second aspect or the sixth possible implementation manner of the second aspect, in a seventh possible implementation manner of the second aspect, the display unit is further configured to display at least a part of the text according to an initial size.

According to a third aspect, a touchscreen device is provided, where the touchscreen device includes a touchscreen configured to display text, where the touchscreen is further configured to acquire an input of a user; and a processor configured to enlarge text in a first preset area according to the input of the user acquired by the touchscreen, and at the same time, reduce text in a second preset area, to enable display of the text to stay in an initial state, where the touchscreen is further configured to display the text in the first preset area and at the same time display the text in the second preset area according to processing of the processor; to enable display of the text to stay in an initial state means to enable a character in the text to stay displayed at a location in a row and/or a column in which the character in the text is displayed before the enlarging text in a first preset area, and at the same time, reducing text in a second preset area is executed; the enlarging text in a first preset area includes enlarging a character and/or character spacing in the text in the first preset area; and the reducing text in a second preset area includes reducing a character and/or character spacing in the text in the second preset area.

In a first possible implementation manner of the third aspect, the touchscreen is configured to acquire a touch location of the user; the processor is configured to, according to the touch location acquired by the touchscreen, enlarge text in an area, of at least one character or at least one pixel, in proximity to the touch location, and at the same time, reduce text in an area, of at least one character or at least one pixel, in proximity to the first preset area and outside the first preset area; and the touchscreen is further configured to display the text in the first preset area and at the same time display the text in the second preset area according to the processing of the processor.

With reference to the first possible implementation manner of the third aspect, in a second possible implementation manner, the touchscreen is further configured to acquire a movement of the touch location; the processor is further configured to determine a location of the first preset area and a location of the second preset area according to the movement of the touch location acquired by the touchscreen; and the touchscreen is further configured to enlarge and display text in the first preset area and at the same time reduce and display text in the second preset area according to the location of the first preset area and the location of the second preset area that are acquired by the processor.

With reference to the first possible implementation manner of the third aspect or the second possible implementation manner of the third aspect, in a third possible implementation manner of the third aspect, the touchscreen is further configured to display, in proximity to the touch location, a character or graphics; the touchscreen is further configured to acquire the movement of the touch location; the processor is further configured to acquire a display location of the character or the graphics according to the movement of the touch location; and the touchscreen is further configured to display the character or the graphics according to the display location of the processor.

With reference to the third possible implementation manner of the third aspect, in a fourth possible implementation manner, the processor is further configured to, if the character or the graphics is in the first preset area, enlarge the character or the graphics; and the touchscreen is further configured to display the enlarged character or graphics.

In a fifth possible implementation manner of the third aspect, the touchscreen is further configured to acquire a particular character; the processor is further configured to enlarge the particular character according to the particular character acquired by the touchscreen, and at the same time, reduce text in an area, of at least one character or at least one pixel, in proximity to the particular character; and the touchscreen is configured to display the enlarged particular character and at the same time reduce and display the text in the area, of at least one character or at least one pixel, in proximity to the particular character according to the processing of the processor.

With reference to the fifth possible implementation manner of the third aspect, in a sixth possible implementation manner, the processor being configured to according to the particular character acquired by the touchscreen includes acquiring the particular character according to a character entered by the user; or acquiring the particular character according to an instruction entered by the user.

With reference to the third aspect or the first possible implementation manner of the third aspect or the second possible implementation manner of the third aspect or the third possible implementation manner of the third aspect or the fourth possible implementation manner of the third aspect or the fifth possible implementation manner of the third aspect or the sixth possible implementation manner of the third aspect, in a seventh possible implementation manner of the third aspect, the display unit is further configured to display at least a part of the text according to an initial size.

In embodiments of the present disclosure, a part of text is enlarged while a part of the text is reduced according to a requirement of a user, which makes it convenient for the user to view/edit the text without changing an original arrangement of the text. This facilitates user operations performed on the text, for example, viewing and editing, improves operation efficiency of the user, and improves user experience.

### BRIEF DESCRIPTION OF DRAWINGS

To describe the technical solutions in the embodiments of the present disclosure or in the prior art more clearly, the following briefly introduces the accompanying drawings required for the embodiments. The accompanying drawings in the following description show some embodiments of the present disclosure, and a person of ordinary skill in the art may still derive other drawings from these accompanying drawings without creative efforts.

FIG. 1 is a flowchart of a possible implementation manner of a text processing method according to Embodiment 1 of the present disclosure;

FIG. 2A, FIG. 2B and FIG. 2C and FIG. 2E, FIG. 2F and FIG. 2G are schematic diagrams of display obtained after the text processing method is performed in Embodiment 1 of the present disclosure;

FIG. 2D is a schematic diagram of display obtained before the text processing method is performed in Example 1 of the present disclosure;

FIG. 3 is a flowchart of another possible implementation manner of the text processing method according to Embodiment 1 of the present disclosure;

FIG. 4 is a flowchart of another possible implementation manner of the text processing method according to Embodiment 1 of the present disclosure;

FIG. 5 is a flowchart of another possible implementation manner of the text processing method according to Embodiment 1 of the present disclosure;

FIG. 6 is a schematic diagram of a structure of a touchscreen device according to Embodiment 2 of the present disclosure; and

FIG. 7 is a schematic diagram of a structure of a mobile phone according to Embodiment 3 of the present disclosure.

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

The terms used in the embodiments of the present disclosure are merely for the purpose of illustrating embodiments, and are not intended to limit the present disclosure. The terms “a”, “said” and “the” of singular forms used in the embodiments and the appended claims of the present disclosure are also intended to include plural forms, unless otherwise specified in the context clearly. It should also be understood that the term “and/or” used herein indicates and includes any or all possible combinations of one or more associated listed items. It should be further understood that the term “include” adopted in the specification specifies presence of features, integers, steps, operations, elements and/or components, with presence or attachment of other features, integers, steps, operations, components, elements, and their combinations not excluded.

It should be understood that, although terms such as first and second may be used in the embodiments of the present disclosure to describe various preset areas, these preset areas should not be limited to these terms. These terms are only used to differentiate the preset areas from each other. For example, without departing from the scope of the embodiments of the present disclosure, a first preset area may be also referred to as a second preset area, and similarly, a second preset area may be also referred to as a first preset area.

In the embodiments of the present disclosure, a touchscreen device includes, but is not limited to a mobile communications device such as a mobile phone, a personal digital assistant (PDA), a tablet computer, or a portable device (for example, a portable computer), also includes a device having a touchscreen, for example, an automatic teller machine (ATM), and may further include a device having a touchscreen, for example, a digital camera, which is not limited in the embodiments of the present disclosure.

The touchscreen may be an input/input interface for a user to interact with a device. One or more graphics may be displayed on a user interface, and the user may select the graphics by, for example, coming into contact with or touching the one or more graphics using one or more fingers. In some embodiments, the one or more graphics are selected when the user breaks contact with the one or more graphics, and in some embodiments, the one or more graphics are selected when the user establishes contact with the one or more graphics. In some embodiments, the contact may include gestures, for example, one or more taps, one or more swipes (from left to right, from right to left, upwards and/or downwards), and scrolling (from right to left, from left to right, upwards and/or downwards) using a finger that is already in contact with the touchscreen. In some embodiments, unintentional contact with graphics will not select the graphics. It should be noted that, the contact in the present disclosure includes direct contact or indirect contact with the touchscreen, and further includes a floating operation above the touchscreen, which is not limited in the embodiments of the present disclosure.

### Embodiment 1

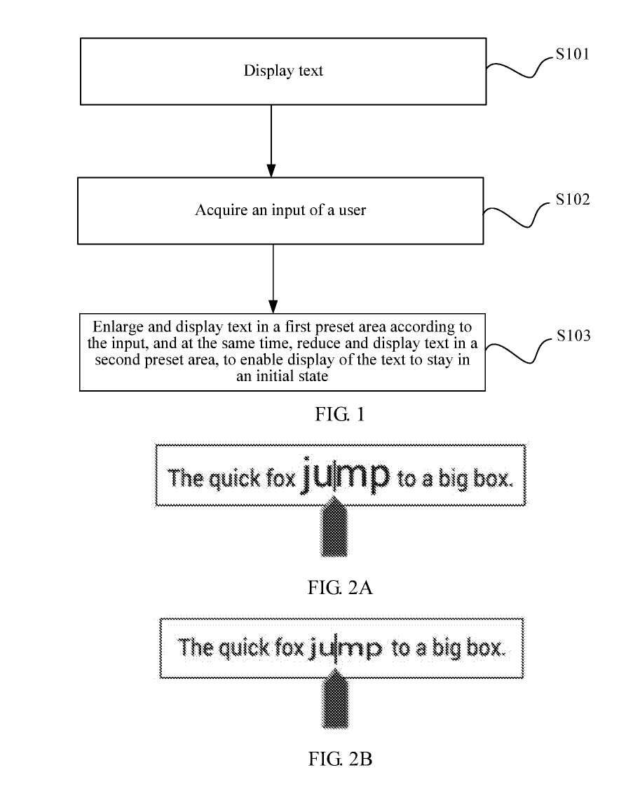

FIG. 1 is a flowchart of a text processing method according to Embodiment 1 of the present disclosure.

As shown in FIG. 1, the text processing method may include the following steps.

S101: Display text.

The text is displayed on a touchscreen device, where the text may be editable text or text that cannot be edited. The text is a document type of a computer, and this type of document is mainly used to record and/or store information such as text or a character. Generally, the document type is not used to record and/or store an image, a sound, and formatted data. A common extension of the text is .txt, .doc, .docx, .wps or the like.

S102: Acquire an input of a user.

The touchscreen device acquires the input of the user, where the input of the user may be obtained using a touchscreen, or may be obtained using another peripheral of the touchscreen device. When a touchscreen terminal acquires the input of the user using the touchscreen, the user may complete the input by, for example, coming into contact with or touching one or more graphics using one or more fingers, may complete the input using a sliding track, or may complete the input using a gesture.

Optionally, the acquiring an input of a user may include a combination of any one or more of the following: acquiring a touch location of the user, acquiring an instruction, and acquiring a particular character. The instruction may include an edit instruction, a search instruction, a check instruction, or the like.

S103: Enlarge and display text in a first preset area according to the input, and at the same time, reduce and display text in a second preset area, to enable display of the text to stay in an initial state. To enable display of the text to stay in an initial state means to enable a character in the text to stay displayed at a location in a row and/or a column in which the character in the text is displayed before the enlarging and displaying text in a first preset area and at the same time reducing and displaying text in a second preset area is executed; the enlarging and displaying text in a first preset area includes enlarging and displaying a character and/or character spacing in the text in the first preset area; and the reducing and displaying text in a second preset area includes reducing and displaying a character and/or character spacing in the text in the second preset area.

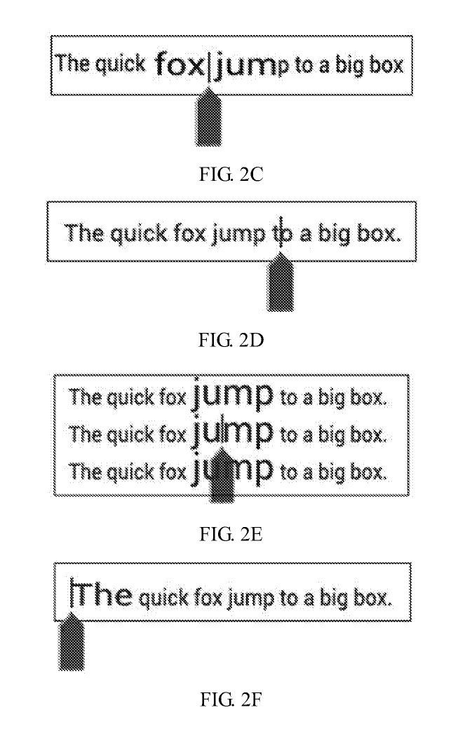

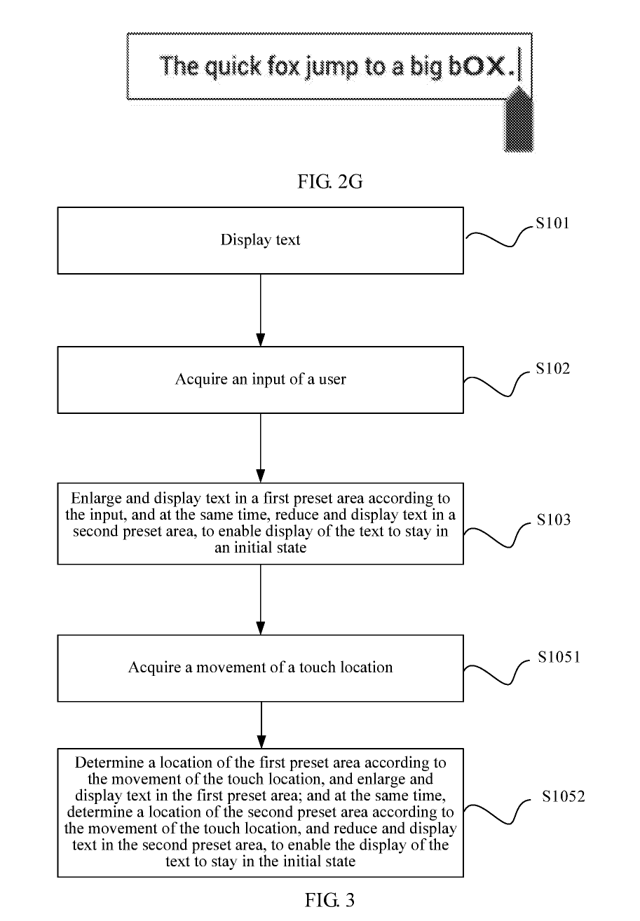

FIG. 2A, FIG. 2B and FIG. 2C are schematic diagrams of display obtained after the text in the first preset area is enlarged and displayed, and at the same time the text in the second preset area is reduced and displayed. FIG. 2D is a schematic diagram of display obtained before the text in the first preset area is enlarged and displayed, and at the same time the text in the second preset area is reduced and displayed. As shown in FIG. 2A, character spacing in the text in the first preset area is enlarged and displayed, and at the same time character spacing in the text in the second preset area is reduced and displayed. As shown in FIG. 2B, characters in the text in the first preset area are enlarged and displayed, and at the same time characters in the text in the second preset area are reduced and displayed. As shown in FIG. 2C, the characters and character spacing in the text in the first preset area are enlarged and displayed, and at the same time the characters and character spacing in the text in the second preset area are reduced and displayed. The initial state refers to a location in a row and/or a column in which the text is displayed in step 5101, and for details, reference may be made to FIG. 2D. As shown in FIG. 2A, FIG. 2B and FIG. 2C, a part of the text is reduced while a part of the text is enlarged, such that the display of the text stays in the initial state. That is, a character in the text is still displayed in a row, as shown in FIG. 2D, in which the character of the text is displayed. It should be noted that, for text arranged according to different writing or reading habits, the enabling display of the text to stay in an initial state may further include enabling a character in the text to be still displayed in a column at an initial location in which the character is displayed, or enabling a character in the text to be still displayed in a row and a column at an initial location in which the character is displayed. It should be noted that the first preset area may be in the shape of a rectangle or a circle, or may be in any shape preset by a system or preset by the user.

In this embodiment of the present disclosure, a part of text is enlarged while a part of the text is reduced according to a requirement of a user, which makes it convenient for the user to view/edit the text without changing an original arrangement of the text. This facilitates user operations performed on the text, for example, viewing and editing, improves operation efficiency of the user, and improves user experience.

Optionally, when the acquiring an input of a user in step S102 includes acquiring the touch location of the user, in step S103, the first preset area is an area, of at least one character or at least one pixel, in proximity to the touch location, and the second preset area is an area, of at least one character or at least one pixel, in proximity to the first preset area and outside the first preset area. More specifically, the area, of at least one character or at least one pixel, in proximity to the touch location may be, as shown in FIG. 2A, FIG. 2B and FIG. 2C and in FIG. 2E, an area, of at least one character or at least one pixel, with the touch location as a center (where the center may be an absolute center, or may be not an absolute center, that is, areas on two sides of or above and below the touch location may be asymmetric); or may be, as shown in FIG. 2F and FIG. 2G, an area, of at least one character or at least one pixel, on one side of the touch location (where especially when the touch location is on an edge of the touchscreen, only an area on one side of the touch location may be enlarged and displayed); or may be an area, of at least one character or at least one pixel, at the location of the touch (that is, a character or a pixel located at the touch location is enlarged and displayed). The one character may further include one word or one phrase recognized using an intelligent recognition mechanism of the touchscreen device. It should be noted that the area of at least one character or at least one pixel may be set by the user, or may be preset by a program, which is not limited in this embodiment of the present disclosure. Further optionally, an enlarged and displayed area in this embodiment of the present disclosure may be a circle, a rectangle, or the like. The second preset area is the area, of at least one character or at least one pixel, in proximity to the first preset area and outside the first preset area, where the area in proximity to the first preset area and outside the first preset area may include an area, excluding the first preset area, with the first preset area as a center, or may include an area, excluding the first preset area, on one side of the first preset area. Similarly, the character and the pixel in the second preset area and the character and the pixel in the first preset area may have same or similar meanings.

In this embodiment of the present disclosure, content of an enlarged region is adjusted according to a touch location of a user, such that the enlarged region may change according to a requirement of the user, which facilitates user operations performed on text, for example, viewing and editing, improves operation efficiency of the user, and improves user experience.

Optionally, as shown in FIG. 2A, FIG. 2B and FIG. 2C and in FIG. 2E, FIG. 2F and FIG. 2G, during step S103, the method may further include S104: display at least a part of the text according to an initial size.

According to the initial state, after a character in a part of the text is enlarged and a character in a part of the text is reduced, a part of the text may further be displayed according to the initial size while the display of the text is kept in the initial state, where the initial size may include a size of a character in the initial state and/or a size of character spacing in the initial state.

Optionally, as shown in FIG. 3, when the acquiring an input of a user in step S102 includes acquiring the touch location of the user, after step S103, the method further includes S1051: acquire a movement of the touch location; and S1052: determine a location of the first preset area according to the movement of the touch location, and enlarge and display text in the first preset area; and at the same time, determine a location of the second preset area according to the movement of the touch location, and reduce and display text in the second preset area, to enable the display of the text to stay in the initial state.

According to the movement of the touch location of the user, content of the enlarged and displayed text is changed and at the same time, content of the reduced and displayed text is changed. The movement of the touch location of the user may be a contact or contactless movement, on the touchscreen, of a finger (or another auxiliary device) of the user. The content of the enlarged and displayed text is changed according to the movement of the user, such that the user may change the content of the enlarged and displayed text according to a requirement anytime. Optionally, when the finger (or the other auxiliary device) of the user leaves the touchscreen or is at a particular distance away from the touchscreen, the enlarging and displaying, and the reducing and displaying of the parts of the text may be canceled, and the entire text is displayed according to the initial size, or a display state before the user leaves the touchscreen may remain.

In this embodiment of the present disclosure, content of an enlarged region is adjusted according to a touch location of a user, such that the enlarged region may change according to a requirement of the user, which facilitates user operations performed on text, for example, viewing and editing, improves operation efficiency of the user, and improves user experience.

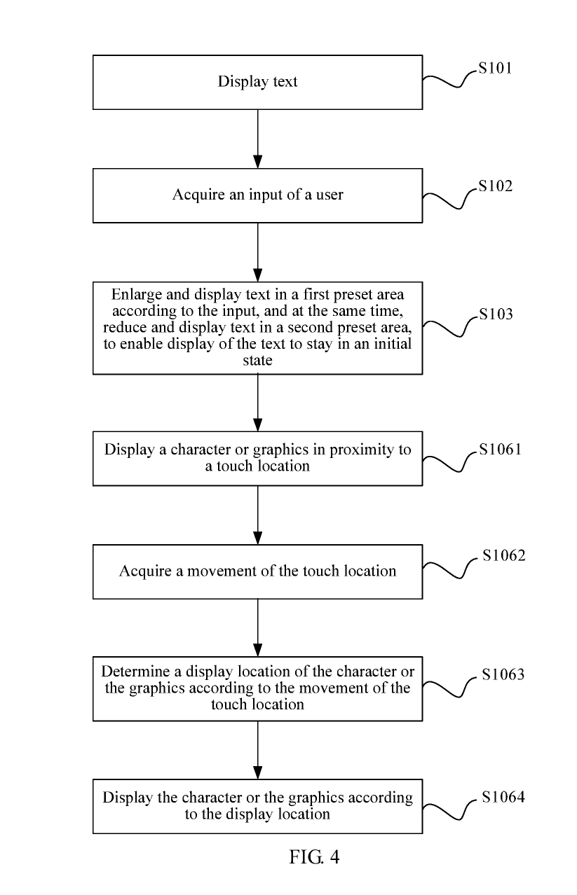

Optionally, as shown in FIG. 4, when the acquiring an input of a user in step S102 includes acquiring the touch location of the user, during or after step S103, the method further includes S1061: display a character or graphics in proximity to the touch location; S1062: acquire a movement of the touch location; S1063: determine a display location of the character or the graphics according to the movement of the touch location; and S1064: display the character or the graphics according to the display location.

The displaying, in proximity to the touch location, a character or graphics includes displaying, in proximity to the touch location, a preset character or picture, where the presetting may be presetting by the system, or may be presetting by the user. The character may be a character related to text content at the touch location, for example, an explanation, a remark, or a phonetic symbol. The picture may be a picture in a vector format, or may be a picture in a pixel format; the picture may be a cursor, may be a handle, or may be another related picture.

A cursor may be displayed between characters according to a touch of the user, where the cursor may be displayed in a blinking manner, or may be displayed in a non-blinking manner. When the touch location of the user changes, a display location of the cursor also changes with the change of the touch location of the user, and the cursor is moved to a new touch location for display. In this embodiment of the present disclosure, the display of the cursor may indicate a location of the touch of the user to the user, which helps the user to adjust the touch location of the user.

A handle may also be displayed at the touch location, and at the same time, a cursor is displayed between characters that are in proximity to a display location of the handle; a movement of the touch location is acquired; and display locations of the handle and the cursor are moved according to the movement. A handle may be displayed according to a touch of the user, where in a vivid manner, the handle is used for dragging by the user, and a touch location is moved by dragging the handle. While the handle is displayed, a cursor may be further displayed between characters that are in proximity to a display location of the handle. The handle is moved according to a change of the touch location of the user, and at the same time, a display location of the cursor is moved. In this embodiment of the present disclosure, a handle is displayed in addition to a cursor, which prevents text from being covered when a user moves a touch location. In addition, the handle is added, such that the user moves the touch location in a more vivid manner, producing an effect of dragging.

Optionally, in step S1061 to step S1064, if the character or the graphics is in the first preset area, the character or the graphics is enlarged and displayed. For example, if text in which a cursor is located is enlarged and displayed, that is, the cursor is located in the first preset area, the cursor is also enlarged and displayed at the same time, such that the user sees the cursor more clearly, and the user selects the touch location more conveniently, thereby improving operation efficiency of the user.

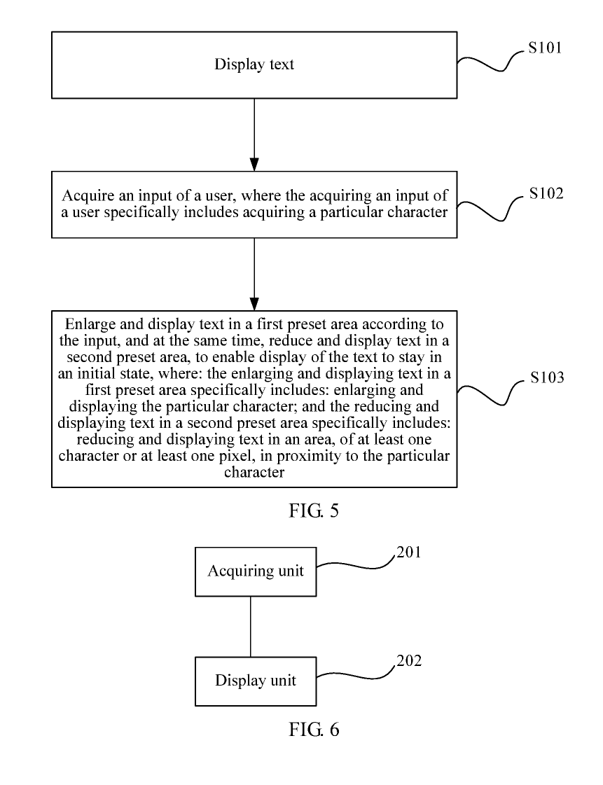

Optionally, as shown in FIG. 5, when the acquiring an input of a user in step S102 includes acquiring a particular character, in step S103, the enlarging and displaying text in a first preset area includes enlarging and displaying the particular character; and the reducing and displaying text in a second preset area includes reducing and displaying text in an area, of at least one character or at least one pixel, in proximity to the particular character. The acquiring a particular character includes acquiring the particular character according to a character entered by the user; or acquiring the particular character according to an instruction entered by the user. The particular character may be the character entered by the user, or may be the character acquired according to the instruction entered by the user. The particular character may be a character that is entered by the user and needs to be searched for by the user, or may be a character that is entered by the user and is expected, by the user, to be displayed in a special manner, or may be a character that is entered by the user and needs to be edited. The particular character may further be a particular erroneous character, where the user enters an error check instruction, and the device checks whether an error exists in the text according to the error check instruction, and enlarges and display the particular erroneous character according to a check result. While the particular character is enlarged and displayed, text in an area, of at least one character or at least one pixel, in proximity to the particular character is reduced and displayed. In this embodiment of the present disclosure, diversified viewing and editing requirements of a user are satisfied by enlarging and displaying a particular character, which facilitates search, an error check, and the like, and improves use efficiency of the user.

### Embodiment 2

FIG. 6 is a schematic diagram of a structure of a touchscreen apparatus according to Embodiment 2. As shown in FIG. 6, the touchscreen apparatus in this embodiment of the present disclosure includes a display unit 202 configured to display text; and an acquiring unit 201 configured to acquire an input of a user, where the display unit 202 is further configured to enlarge and display text in a first preset area according to the input of the user acquired by the acquiring unit 201, and at the same time, reduce and display text in a second preset area, to enable display of the text to stay in an initial state, where to enable display of the text to stay in an initial state means to enable a character in the text to stay displayed at a location in a row and/or a column in which the character in the text is displayed before the enlarging and displaying text in a first preset area and at the same time reducing and displaying text in a second preset area is executed; the enlarging and displaying text in a first preset area includes enlarging and displaying a character and/or character spacing in the text in the first preset area; and the reducing and displaying text in a second preset area includes reducing and displaying a character and/or character spacing in the text in the second preset area.

Optionally, the display unit 202 is further configured to display at least a part of the text according to an initial size.

Optionally, the acquiring unit 201 is configured to acquire a touch location of the user; and the display unit 202 is configured to, according to the touch location acquired by the acquiring unit 201, enlarge and display text in an area, of at least one character or at least one pixel, in proximity to the touch location, and at the same time, reduce and display text in an area, of at least one character or at least one pixel, in proximity to the first preset area and outside the first preset area.

The display unit 202 is configured to implement the methods of step S101, step S103, and step S104 in Embodiment 1 of the present disclosure, and the acquiring unit 201 is configured to execute the method of step S102 in Embodiment 1 of the present disclosure. For specific methods, reference is made to Embodiment 1 of the present disclosure, and details are not described herein again.

Optionally, the acquiring unit 201 is further configured to acquire a movement of the touch location, and acquire a location of the first preset area according to the movement of the touch location and/or acquire a location of the second preset area according to the movement of the touch location; and the display unit 202 is further configured to enlarge and display text in the first preset area and at the same time reduce and display text in the second preset area according to the location of the first preset area and the location of the second preset area that are acquired by the acquiring unit. The display unit 202 is configured to implement the method of step S1052 in Embodiment 1 of the present disclosure, and the acquiring unit 201 is configured to execute the method of step S1051 in Embodiment 1 of the present disclosure. For specific methods, reference is made to Embodiment 1 of the present disclosure, and details are not described herein again.

Optionally, the display unit 202 is further configured to display, according to the touch location acquired by the acquiring unit 201, a character or graphics in proximity to the touch location; the acquiring unit 201 is further configured to acquire the movement of the touch location; and the display unit 202 is further configured to display the character or the graphics according to the movement acquired by the acquiring unit 201. The display unit 202 is configured to implement the methods of step S1061 and S1063 in Embodiment 1 of the present disclosure, and the acquiring unit 201 is configured to execute the method of step 1062 in Embodiment 1 of the present disclosure. For specific methods, reference is made to Embodiment 1 of the present disclosure, and details are not described herein again.

Optionally, the display unit 202 is further configured to display, according to the touch location acquired by the acquiring unit 201, a handle at the touch location, and display a cursor between characters that are in proximity to a display location of the handle; the acquiring unit 201 is further configured to acquire the movement of the touch location; and the display unit 202 is further configured to display the handle and the cursor according to the movement acquired by the acquiring unit 201.

Optionally, the display unit 202 is further configured to, if the character or the graphics is in the first preset area, enlarge and display the character or the graphics.

Optionally, the acquiring unit 201 is further configured to acquire a particular character; and the display unit 202 is further configured to enlarge and display the particular character according to the particular character acquired by the acquiring unit 201, and at the same time, reduce and display text in an area, of at least one character or at least one pixel, in proximity to the particular character. The display unit 202 is configured to implement the methods of step S101 and S103 in Embodiment 1 of the present disclosure, and the acquiring unit 201 is configured to execute the method of step 102 in Embodiment 1 of the present disclosure. For specific methods, reference is made to Embodiment 1 of the present disclosure, and details are not described herein again.

In this embodiment of the present disclosure, by means of a touch apparatus, a part of text is enlarged while a part of the text is reduced according to a requirement of a user, which makes it convenient for the user to view/edit the text without changing an original arrangement of the text. This facilitates user operations performed on the text, for example, viewing and editing, improves operation efficiency of the user, and improves user experience.

### Embodiment 3

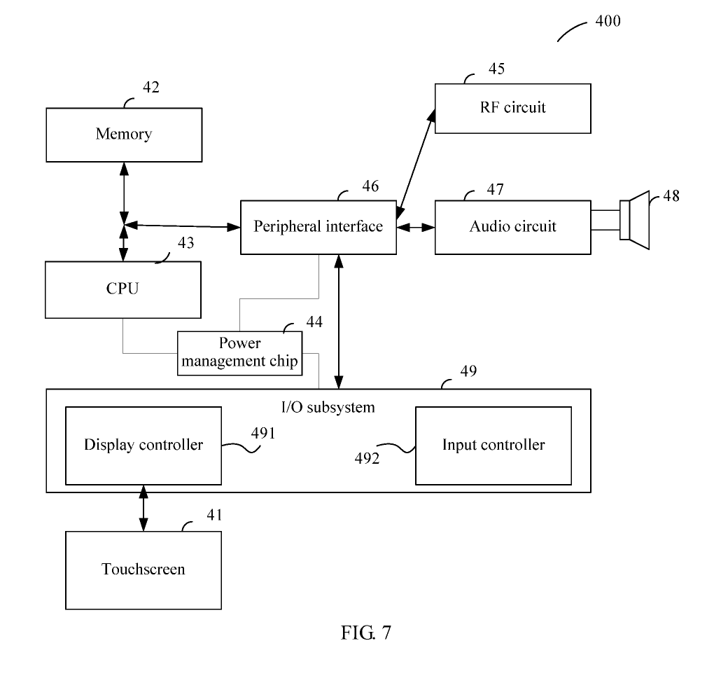

A touchscreen device for processing a user interface is provided, including a touchscreen, a memory, a processor, a power management chip, a radio frequency (RF) circuit, a peripheral interface, an audio circuit, a loudspeaker, and an input/output (I/O) subsystem. The touchscreen is configured to display text and is further configured to acquire an input of a user; the processor is configured to enlarge text in a first preset area according to the input of the user acquired by the touchscreen, and at the same time, reduce text in a second preset area, to enable display of the text to stay in an initial state; and the touchscreen is further configured to display the text in the first preset area and at the same time display the text in the second preset area according to processing of the processor. This embodiment of the present disclosure is described in detail using a mobile phone as an example. FIG. 7 is a schematic diagram of a structure of the touchscreen device according to Embodiment 3. As shown in FIG. 7, a mobile phone 400 includes a touchscreen 41, a memory 42, a processor 43, a power management chip 44, an RF circuit 45, a peripheral interface 46, an audio circuit 47, a loudspeaker 48, and an I/O subsystem 49. It should be understood that the mobile phone shown in FIG. 7 is merely an example of the touchscreen device, and the mobile phone may have more or less components than those shown in the figure, may combine two or more components, or may have different component configurations. The various components shown in the figure may be implemented by hardware including one or more signal processing and/or application-specific integrated circuits, software, or a combination of software and hardware.

The touchscreen 41 is configured to display text, is further configured to acquire an input of a user, and is further configured to display text in a first preset area and at the same time display text in a second preset area according to processing of the processor. The touchscreen 41 is configured to execute the method in Embodiment 1, and for details, reference is made to the methods of step S101, step S102, step S103, and step S104 in Embodiment 1. For the specific methods, reference is made to the methods in Embodiment 1, and details are not described herein again. The touchscreen 41 is an input interface and an output interface between the mobile phone and the user. In addition to having functions of acquiring touch information and a control instruction of the user, the touchscreen presents a visual output to the user, where the visual output may include graphics, text, an icon, a video, and the like.

The memory 42 may be configured to store the touch information. The touch information includes information about a touch location, information about touch pressure, and the like. The memory 42 may be accessed by the processor 43, the peripheral interface 46, and the like, and the memory 42 may include a high-speed random access memory, or may include a non-volatile memory such as one or more magnetic disk storage devices, a flash memory device, or another volatile solid-state storage device.

The processor 43 may be configured to enlarge the text in the first preset area according to the input of the user acquired by the touchscreen, and at the same time, reduce the text in the second preset area, to enable display of the text to stay in an initial state. The processor 43 is configured to execute the method in Embodiment 1, and for details, reference is made to the method of step S103 in Embodiment 1. Reference is made to the method in Embodiment 1 for the specific method, and details are not described herein again. The processor 43 is a control center of the mobile phone 400, and is connected to each part of the mobile phone 400 using various interfaces and lines. By running or executing a software program and/or module stored in the memory 42, and invoking data stored in the memory 42, the processor 43 performs various functions and data processing of the mobile phone 400, thereby performing overall monitoring on the mobile phone 400. Optionally, the processor 43 may include one or more processing units. Preferably, the processor 43 may integrate an application processor and a modem processor. Optionally, the application processor mainly processes an operating system, a user interface, an application program, and the like. The modem processor mainly processes wireless communication. It may be understood that the foregoing modem processor may not be integrated into the processor 43. It should be further noted that the foregoing function is only one of functions that can be performed by the processor 43, and other functions are not limited in this embodiment of the present disclosure.

The power management chip 44 may be configured to supply power to and perform power management on hardware to which the processor 43, the I/O subsystem 49, and the peripheral interface 46 are connected.

The RF circuit 45 is mainly configured to establish communication between the mobile phone and a wireless network (that is, a network side), to implement data acquiring and sending between the mobile phone and the wireless network, for example, receiving and sending a short message service message or an e-mail. The RF circuit 45 acquires and sends an RF signal, where the RF signal is also referred to as an electromagnetic signal. The RF circuit 45 converts an electrical signal into an electromagnetic signal or converts an electromagnetic signal into an electrical signal, and communicates with a communications network and another device using the electromagnetic signal. The RF circuit 45 may include a given circuit for performing these functions, which includes but is not limited to, an antenna system, an RF transceiver, one or more amplifiers, a tuner, one or more oscillators, a digital signal processor, a coder-decoder (CODEC) chip set, a subscriber identity module (SIM), and the like.

For the peripheral interface 46, the peripheral interface may connect an input/output peripheral of the device to the processor 43 and the memory 42.

The audio circuit 47 may be mainly configured to acquire audio data from the peripheral interface 46, convert the audio data into an electrical signal, and send the electrical signal to the loudspeaker 48.

The loudspeaker 48 may be configured to restore a sound from a voice signal that is acquired by the mobile phone from the wireless network using the RF circuit 45, and play the sound to the user.

For the I/O subsystem 49, the I/O subsystem 49 may control an input/output peripheral on the device, and the I/O subsystem 49 may include a display controller 491 and one or more input controllers 492 configured to control another input/control device. Optionally, the one or more input controllers 492 acquires an electrical signal from the other input/control device or sends an electrical signal to the other input/control device, where the other input/control device may include a physical button (a press button, a rocker button, or the like), a dial, a slider switch, a joystick, and a click scroll wheel. It should be noted that the input controller 492 may be connected to any one of the following: a keyboard, an infrared port, a universal serial bus (USB) interface, and an indication device such as a mouse. The display controller 491 of the I/O subsystem 49 acquires an electrical signal from the touchscreen 41 or sends an electrical signal to the touchscreen 41. The touchscreen 41 acquires a contact on the touchscreen, and the display controller 491 converts the acquired contact into interaction with a user interface object presented on the touchscreen 41, that is, human machine interaction is implemented. The user interface object presented on the touchscreen 41 may be an icon for running a game, an icon for a connection to a corresponding network, a filter mode, or the like. It should be noted that the device may further include an optical mouse, where the optical mouse is a touch-sensitive surface that presents no visual output, or is an extension of a touch-sensitive surface formed by the touchscreen.

In Embodiment 3 of the present disclosure, the touchscreen 41 may display the text shown in FIG. 2D, and acquire the input of the user. The processor 43 enlarges the text in the first preset area according to the input of the user acquired by the touchscreen, and at the same time, reduces the text in the second preset area, to enable the display of the text to stay in the initial state. The touchscreen 41 may further display the text in the first preset area and at the same time display the text in the second preset area according to the processing of the processor, for example, the text shown in FIG. 2A, FIG. 2B and FIG. 2C and in FIG. 2E, FIG. 2F and FIG. 2G. The foregoing structure may be configured to execute the method in Embodiment 1. For the specific method, reference is made to the method in Embodiment 1, and details are not described again herein.

In this embodiment of the present disclosure, using a touch device, a part of text is enlarged while a part of the text is reduced according to a requirement of a user, which makes it convenient for the user to view/edit the text without changing an original arrangement of the text. This facilitates user operations performed on the text, for example, viewing and editing, improves operation efficiency of the user, and improves user experience.

With descriptions of the foregoing implementation manners, a person skilled in the art may clearly understand that the embodiments of the present disclosure may be implemented by hardware, firmware or a combination thereof When the embodiments of the present disclosure are implemented by software, the foregoing functions may be stored in a terminal-readable medium or transmitted as one or more instructions or code in the terminal-readable medium. The terminal-readable medium includes a terminal storage medium and a communications medium. Optionally, the communications medium includes any medium that enables a terminal program to be transmitted from one place to another. The storage medium may be any available medium accessible to a terminal. The following provides an example but does not impose a limitation. The terminal-readable medium may include a random access memory (RAM), a read-only memory (ROM), an electrically erasable programmable read-only memory (EEPROM), a compact disc read-only memory (CD-ROM), or another optical disc storage or a disk storage medium, or another magnetic storage device, or any other medium that can carry or store expected program code in a form of an instruction or a data structure and can be accessed by a terminal. In addition, any connection may be appropriately defined as a terminal-readable medium. For example, if software is transmitted from a website, a server or another remote source using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in a definition of a medium to which they belong. For example, a disk and disc used by the embodiments of the present disclosure includes a compact disc (CD), a laser disc, an optical disc, a digital versatile disc (DVD), a floppy disk and a Blu-ray disc. Optionally, the disk generally copies data by a magnetic means, and the disc copies data optically by a laser means. The foregoing combination should also be included in the protection scope of the terminal-readable medium.

In short, the foregoing descriptions are only embodiments of the technical solutions of the present disclosure, but are not intended to limit the protection scope of the present disclosure. Any modification, equivalent replacement, or improvement made without departing from the spirit and principle of the present disclosure shall fall within the protection scope of the present disclosure.

1. A text processing method, comprising:
displaying text;
acquiring an input of a user;
enlarging and displaying text in a first preset area according to the input, and at the same time; and
reducing and displaying text in a second preset area to enable display of the text to stay in an initial state, wherein to enable display of the text to stay in the initial state means to enable a character in the text to stay displayed at a location in a row and/or a column in which the character in the text is displayed before enlarging and displaying text in the first preset area and at the same time reducing and displaying text in the second preset area is executed,
wherein enlarging and displaying text in the first preset area comprises enlarging and displaying a character and/or character spacing in the text in the first preset area, and
wherein reducing and displaying text in the second preset area comprises reducing and displaying a character and/or character spacing in the text in the second preset area.

2. The method according to claim 1, wherein acquiring the input of the user comprises acquiring a touch location of the user, wherein the first preset area is an area of at least one character or at least one pixel and in proximity to the touch location, and wherein the second preset area is an area of at least one character or at least one pixel and in proximity to the first preset area and outside the first preset area.

3. The method according to claim 2, wherein after enlarging and displaying text in the first preset area according to the input, and at the same time as reducing and displaying text in the second preset area, the method further comprises:
acquiring a movement of the touch location;
determining a location of the first preset area according to the movement of the touch location, and enlarging and displaying text in the first preset area; and at the same time; and
determining a location of the second preset area according to the movement of the touch location, and reducing and displaying text in the second preset area, to enable the display of the text to stay in the initial state.

4. The method according to claim 2, wherein after enlarging and displaying text in the first preset area according to the input, and at the same time as reducing and displaying text in the second preset area, the method further comprises:
displaying, in proximity to the touch location, a character or graphics;
acquiring a movement of the touch location;
determining a display location of the character or the graphics according to the movement of the touch location; and
displaying the character or the graphics according to the display location.

5. The method according to claim 4, wherein the character or the graphics is enlarged and displayed when the character or the graphics is in the first preset area.

6. The method according to claim 1, wherein acquiring the input of then user comprises acquiring a particular character, wherein enlarging and displaying text in the first preset area comprises enlarging and displaying the particular character, and wherein reducing and displaying text in the second preset area comprises reducing and displaying text in an area of at least one character or at least one pixel and in proximity to the particular character.

7. The method according to claim 6, wherein acquiring the particular character comprises:
acquiring the particular character according to a character entered by the user; or
acquiring the particular character according to an instruction entered by the user.

8. The method according to claim 1, wherein during enlarging and displaying text in the a-first preset area according to the input, and at the same time, time as reducing and displaying text in the second preset area, to enable display of the text to stay in the initial state, the method further displaying at least a part of the text according to an initial size.

9-16. (canceled)

17. A touchscreen device, wherein the touchscreen device comprises:
a touchscreen configured to:
display text; and,
acquire an input of a user; and
a processor coupled to the touchscreen and configured to:
enlarge text in a first preset area according to the input of the user acquired by the touchscreen; and
simultaneously. reduce text in a second preset area, to enable display of the text to stay in an initial state,
wherein the touchscreen is further configured to display the text in the first preset area and at the same time display the text in the second preset area according to processing of the processor,
wherein to enable display of the text to stay in the initial state means to enable a character in the text to stay displayed at a location in a row and/or a column in which the character in the text is displayed before the enlarging text in the first preset area, and at the same time, reducing text in the second preset area is executed,
wherein enlarging text in the first preset area comprises enlarging a character and/or character spacing in the text in the first preset area, and
wherein reducing text in the second preset area comprises shrinking a character and/or character spacing in the text in the second preset area.

18. The touchscreen device according to claim 17, wherein the touchscreen is further configured to acquire a touch location of the user, wherein the processor is further configured to, according to the touch location acquired by the touchscreen, enlarge text in an area, of at least one character or at least one pixel, in proximity to the touch location, and at the same time, reduce text in an area, of at least one character or at least one pixel, in proximity to the first preset area and outside the first preset area, and wherein the touchscreen is further configured to display the text in the first preset area and at the same time display the text in the second preset area according to the processing of the processor.

19. The touchscreen device according to claim 18, wherein the touchscreen is further configured to acquire a movement of the touch location, wherein the processor is further configured to determine a location of the first preset area and a location of the second preset area according to the movement of the touch location acquired by the touchscreen; and wherein the touchscreen is further configured to enlarge and display text in the first preset area and at the same time reduce and display text in the second preset area according to the location of the first preset area and the location of the second preset area that are acquired by the processor.

20. The touchscreen device according to claim 18, wherein the touchscreen is further configured to display, in proximity to the touch location, a character or graphics, wherein the touchscreen is further configured to acquire a movement of the touch location, wherein the processor is further configured to acquire a display location of the character or the graphics according to the movement of the touch location, and wherein the touchscreen is further configured to display the character or the graphics according to the display location of the processor.

21. The touchscreen device according to claim 20, wherein the processor is further configured to enlarge the character or the graphics when the character or the graphics is in the first preset area and, wherein the touchscreen is further configured to display the enlarged character or graphics.

22. The touchscreen device according to claim 17, wherein the touchscreen is further configured to acquire a particular character, wherein the processor is further configured to enlarge the particular character according to the particular character acquired by the touchscreen, and at the same time, reduce text in an area, of at least one character or at least one pixel, in proximity to the particular character, and wherein the touchscreen is configured to display the enlarged particular character and at the same time reduce and display the text in the area, of at least one character or at least one pixel, in proximity to the particular character according to the processing of the processor.

23. The touchscreen device according to claim 22, wherein the processor being configured to enlarge the particular character according to the particular character acquired by the touchscreen comprises acquiring the particular character according to a character entered by the user; or acquiring the particular character according to an instruction entered by the user.

24. The touchscreen device according to claim 17, wherein the touchscreen is further configured to display at least a part of the text according to an initial size.
